(19) United States
(12) Patent Application Publication
(10) Pub. No.: US 2021/0020976 A1
(43) Pub. Date: Jan. 21, 2021

(54) UNIT CELL FOR A FUEL CELL AND A METHOD FOR MANUFACTURING A UNIT CELL FOR A FUEL CELL

(71) Applicants: HYUNDAI MOTOR COMPANY, Seoul (KR); KIA MOTORS CORPORATION, Seoul (KR)

(72) Inventors: Chi Seung Lee, Seongnam-si (KR); Young Woo Noh, Guri-si (KR); Seong Hak Kim, Busan (KR); Seung Ah Yu, Incheon (KR); Jae Jun Ko, Gunpo-si (KR); Jang Ho Jo, Yongin-si (KR)

(73) Assignees: HYUNDAI MOTOR COMPANY, Seoul (KR); KIA MOTORS CORPORATION, Seoul (KR)

(21) Appl. No.: 17/064,314

(22) Filed: Oct. 6, 2020

Related U.S. Application Data
(62) Division of application No. 15/729,768, filed on Oct. 11, 2017.

(30) Foreign Application Priority Data
Dec. 14, 2016 (KR) 10-2016-0170573

(51) Int. Cl. H01M 8/2465; H01M 8/0258; H01M 8/0232; H01M 8/0271; H01M 8/1004; H01M 8/0297; H01M 8/0228

(52) U.S. Cl. CPC H01M 8/2465; H01M 8/0258; H01M 8/0232; H01M 8/0271; H01M 8/1004; H01M 2008/1095; H01M 8/0228; H01M 2250/10; H01M 2250/30; H01M 2250/20; H01M 8/0297

(57) ABSTRACT

A method for manufacturing a unit cell for a fuel cell includes preparing a separator having a reaction area located to correspond to an anode or a cathode of the unit cell, a first protrusion protruding from the separator, and a second protrusion spaced apart from the first protrusion with the reaction area interposed therebetween. The method includes providing a passage configured to guide a reaction gas to flow in the reaction area, and arranging a porous passage having a height protruding to become farther away from the separator and to be higher than the first and second protrusions between the first and second protrusions in parallel. The method includes compressing the porous passage toward the separator. The porous passage is fixed to the separator via the first and second protrusions by a force applied between the porous passage and the protrusion as the passage is deformed or is apt to be deformed to be lengthened in a transverse direction due to the compression of the porous passage.

### CROSS-REFERENCE TO RELATED APPLICATION

This application claims priority to and is a division of co-pending U.S. patent application Ser. No. 15/729,768 filed Oct. 11, 2017 and entitled “UNIT CELL FOR A FUEL CELL AND A METHOD FOR MANUFACTURING A UNIT CELL FOR A FUEL CELL”, and which claims priority to and the benefit of Korean Patent Application No. 10-2016-0170573 filed Dec. 14, 2016 in the Korean Intellectual Property Office. The entire contents of these prior filed applications are incorporated herein by reference.

### TECHNICAL FIELD

The present disclosure relates to a unit cell for a fuel cell and a method for manufacturing a unit cell for a fuel cell.

### BACKGROUND

In general, a fuel cell is a kind of power generator configured to convert chemical energy of fuel into electric energy in a fuel cell stack through an electrochemical reaction without converting the chemical energy into thermal energy through combustion. Such a fuel cell may supply industrial electric power, household electric power, and automotive electric power, and may be applied to supply electric power to small-sized electric/electronic products as well, and more particularly, portable devices.

As an example of the fuel cell, a polymer electrolyte membrane fuel cell (PEMFC) is most frequently researched as a power source for driving a vehicle. A PEMFC includes a membrane electrode assembly (MEA) includes catalyst electrode layers in which electrochemical reactions occur. The catalyst electrode layers are attached to opposite sides of an electrolyte membrane through which hydrogen ions move. The PEMFC also includes a gas diffusion layer (GDL) serving to uniformly distribute reaction gases and transfer generated electric energy and a separator configured to move the reaction gases and cooling water. A porous body is applied to the separator. There is a problem in that, while multiple fuel battery cells are stacked on each other and the porous body is stacked to face the gravity direction, the porous body is moved and thus is aligned so as not to be located on a surface of the MEA or the GDL.

In such a PEMFC, due to an alignment error, components themselves and counterpart components may be damaged.

### SUMMARY

The present disclosure provides a unit cell for a fuel cell in which a separator and a porous body are formed integrally with each other such that the porous body is located on a surface of the MEA or the GDL. Stacks may be precisely stacked on each other, so that productivity of the stacks may be improved. The present disclosure also provides a method for manufacturing a unit cell for a fuel cell.

The technical objects of the present disclosure are not limited to the above-mentioned one. Other unmentioned technical objects will become apparent to those having ordinary skill in the art from the following description.

In accordance with an aspect of the present disclosure, a unit cell for a fuel cell is disclosed and described. The unit cell includes a separator having a reaction area located to correspond to an anode or a cathode of a membrane electrode assembly. The separator includes an inlet manifold, which is provided outside the reaction area and into which a reaction gas is introduced that is to be supplied to the reaction area, and includes an outlet manifold, which is spaced apart from the inlet manifold and through which the reaction gas that passed through the reaction area is discharged. The unit cell includes a porous passage provided between the separator and the membrane electrode assembly. The porous passage is arranged to be adjacent to the separator and having a passage configured to guide the reaction gas introduced into the inlet manifold such that the reaction gas is discharged to the outlet manifold via the reaction area. The unit cell includes a protrusion protruding from the separator toward the passage. The porous passage is fixed to the separator by medium of the protrusion through a pressing force to the protrusion. The pressing force is generated due to deformation by a compressive force.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a unit cell for a fuel cell system according to an embodiment of the present disclosure;

FIG. 2 is a view illustrating a state in which a reaction gas flows to an outlet manifold via an inlet manifold according to an embodiment of the present disclosure;

FIG. 3 is a view illustrating a state before a passage is compressed according to an embodiment of the present disclosure;

FIG. 4 is a view illustrating a state in which the passage of FIG. 3 is compressed;

FIG. 5 is a view illustrating a force applied between the passage and a protrusion according to an embodiment of the present disclosure;

FIG. 6 is a block diagram illustrating a method for manufacturing a unit cell for a fuel cell according to an embodiment of the present disclosure;

FIG. 7 is a view illustrating a state before a passage is compressed according to an embodiment of the present disclosure; and

FIG. 8 is a view illustrating a state in which the passage is compressed according to an embodiment of the present disclosure.

### DETAILED DESCRIPTION

In view of the foregoing and/or other problems and disadvantages with prior known fuel cells, an apparatus in which the separator and the porous body are integrated with each other is disclosed and described herein. Hereinafter, embodiments of the present disclosure are described in detail with reference to the accompanying drawings. It should be noted that when components in the drawings are designated by reference numerals, the same components have the same reference numerals as far as possible even though the components are illustrated in different drawings. Further, in describing the embodiments of the present disclosure, when it is determined that detailed descriptions of well-known configurations or functions disturb understanding of the embodiments of the present disclosure, those detailed descriptions have been omitted.

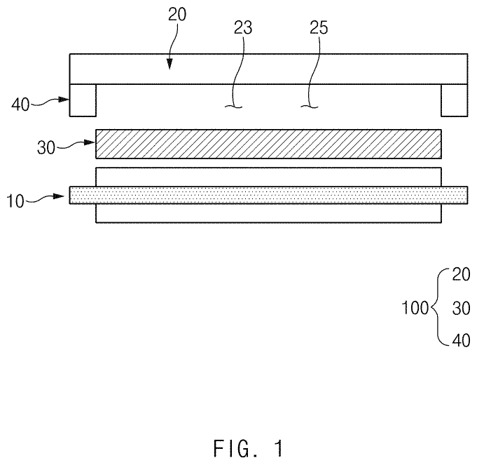

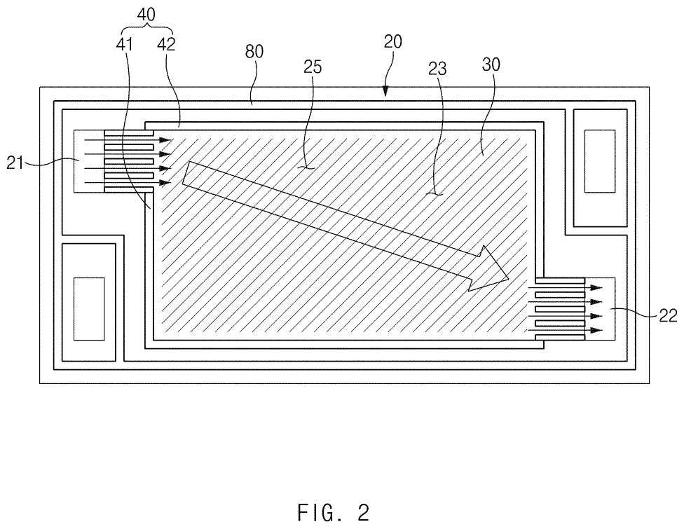

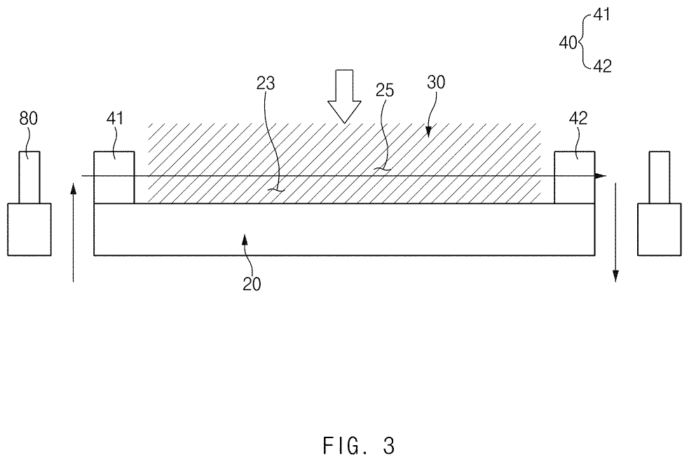

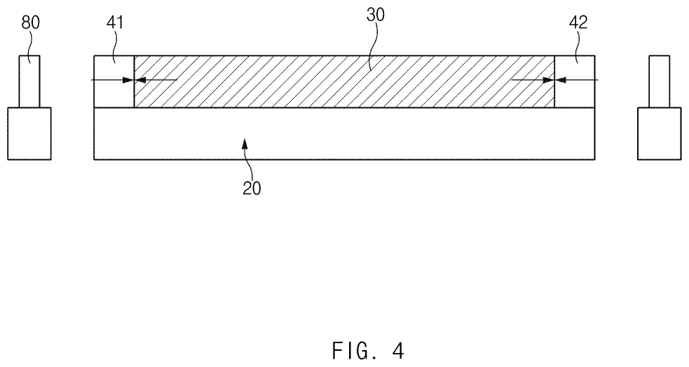

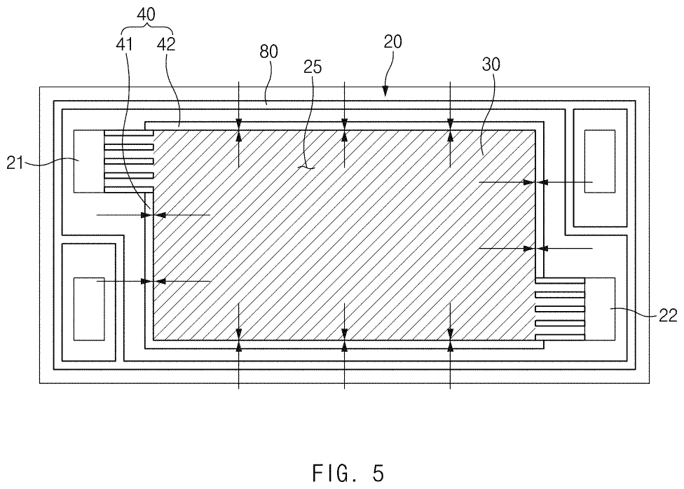

FIG. 1 is a view illustrating a unit cell for a fuel cell system according to an embodiment of the present disclosure. FIG. 2 is a view illustrating a state in which a reaction gas flows to an outlet manifold via an inlet manifold according to an embodiment of the present disclosure. FIG. 3 is a view illustrating a state before a passage is compressed according to an embodiment of the present disclosure. FIG. 4 is a view illustrating a state in which the passage of FIG. 3 is compressed. FIG. 5 is a view illustrating a force applied between the passage and a protrusion according to an embodiment of the present disclosure.

Referring to FIGS. 1-3, a unit cell 100 for a fuel cell includes a separator 20, a passage 30, and a protrusion 40.

As illustrated in FIG. 2, the separator 20 includes a reaction area 23, an inlet manifold 21, and an outlet manifold 22. As illustrated in FIG. 1, the reaction area 23 may be located to correspond to an anode or a cathode of an MEA 10.

As illustrated in FIG. 2, the inlet manifold 21 may be provided outside the reaction area 23, and may be configured to introduce a reaction gas that is to be supplied to the reaction area 23.

The output manifold 22 may be spaced apart from the inlet manifold 21, and may be configured to discharge, from the inlet manifold 21, the reaction gas passing through the reaction area 23.

As illustrated in FIGS. 1 and 2, the passage 30 may be provided between the separator 20 and the MEA 10 arranged to be adjacent to the separator 20.

As an example, the MEA 10 may have a three-layered structure including a cathode, an electrolyte membrane, and an anode. Alternatively, the MEA 10 may have a five-layered structure including a GDL, a cathode, an electrolyte membrane, an anode, and a GDL.

As illustrated in FIGS. 2 and 3, the passage 30 may be formed of a porous material. The passage 30 may provide a passage configured to guide the reaction gas introduced into the inlet manifold 21 via the reaction area 23 to the outlet manifold 22.

As an example, the passage 30 may have a form of a porous body formed using metal foam.

The protrusion 40 may protrude from the separator 20 toward the passage 30.

The passage 30 may be configured to compress or apply a force against the protrusion due to deformation by a compressive force. The passage 30 may be fixed to the separator 20 due to deformation by a compressive force applied in a thickness direction.

A pressing force generated in the passage 30 may be applied from an inside toward an outside of the reaction area 23. The protrusion 40 may fix the passage 30 to the separator 20 by reaction to the pressing force.

As illustrated in FIG. 2, the protrusion 40 may include a first protrusion 41 and a second protrusion 42. The second protrusion 42 may be spaced apart from the first protrusion 41. The second protrusion 42 may be configured to provide an installation space 25 between the first protrusion 41 and the second protrusion 42, in which the passage 30 is installed.

The first and second protrusions 41 and 42 may be provided to surround the reaction area 23. The first and second protrusion 41 and 42 may not be provided in an area communicating with the inlet and outlet manifolds 21 and 22 and the reaction area 23. The first and second protrusion 41 and 42 may face each other with the reaction area 23 interposed therebetween.

The protrusion 40 may be formed integrally with the separator 20 or may be coupled to the separator 20 while being formed separately from the separator 20.

As illustrated in FIG. 3, the passage 30 may have an initial length that is not more than a separation distance between the first and second protrusions 41 and 42.

As illustrated in FIG. 4, upon being compressed, the passage 30 may have a length that is not less than the separation distance between the first and second protrusions. This may be due to the deformation by the compressive force applied in the thickness direction. The passage 30 may thus compress or apply a pressing force against the first and second protrusions 41 and 42.

The pressing force generated due to the deformation of the passage 30 may be applied from the inside toward the outside of the reaction area 23. The protrusion 40 may fix the passage 30 to the separator 20 by the reaction to the pressing force. The passage 30 may be fixed to the separator 30 by medium of the protrusion 40.

The passage may be compressed toward the separator 20 while being installed in the installation space 25. The passage 30 may be deformed to be lengthened toward the first and second protrusions 41 and 42 and thereby may be fixed to the separator 20 by a force applied between the passage 30 and the first and second protrusions 41 and 42.

As illustrated in FIGS. 4 and 5, the passage 30 may be fixed in the installation space 25 by a reaction force by which the first and second protrusions 41 and 42 compress the passage 30. The reaction force is a reaction to the force by which the passage 30 compresses the first and second protrusions 41 and 42 from the inside toward the outside of the installation space 25 due to the deformation of the passage 30.

Further, the passage 30 may have a length corresponding to the separation distance between the first and second protrusions 41 and 42. The passage 30 may be fixed to the separator 20 by a force applied between the passage 30 and the protrusion 40 as the passage 30 is deformed by the fixed protrusion 40. As an example, the passage 30 is not deformed in a state in which the passage 30 is fixed between the first and second protrusions 41 and 42 while being compressed.

As illustrated in FIGS. 3 and 4, the passage 30 may have a quadrangular cross-section. The first and second protrusions 41 and 42 may support surfaces of the passage 30, which correspond to adjacent two sides among four sides constituting the quadrangle.

As an example, a passage (not illustrated) may be formed at a location that is opposite to the reaction area 23 of the separator 20. As an example, the reaction area 23 may protrude due to the formation of the passage (not illustrated) to selectively compress the passage 30.

As an example, the separator 20 to which the passage 30 is fixed may be used when a plurality of unit cells is stacked.

As an example, as illustrated in FIGS. 2-5, to repeatedly stack the separator 20 to which the MEA and the passage 30 are fixed, a gasket 80 may be arranged at an edge of the separator 20. The gasket 80 may be formed of an elastic material, and the height of the gasket 80 may be formed to correspond to the height of the protrusion 40.

As an example, the height of the gasket 80 may be formed to be higher than the protrusion 40, and the gasket 80 is contracted when being compressed, and thus may be configured to prevent the reaction gas from being leaked when the separator 20 to which the MEA 10 and the passage 30 are fixed is repeatedly stacked.

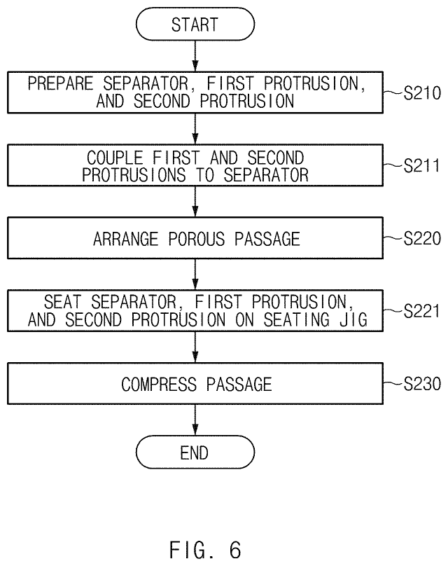

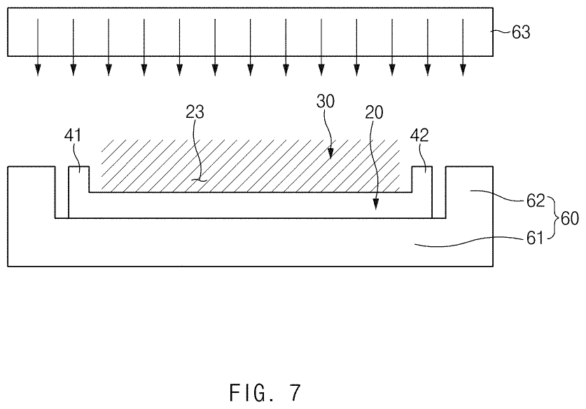

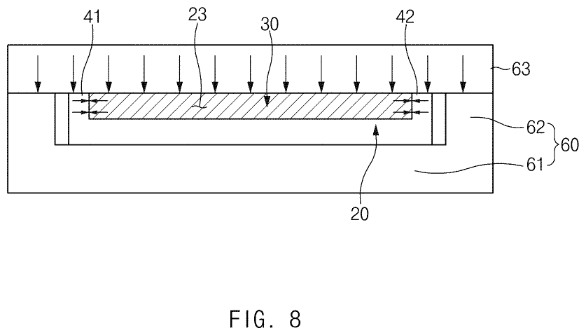

FIG. 6 is a block diagram illustrating a method for manufacturing a unit cell for a fuel cell according to an embodiment of the present disclosure. FIG. 7 is a view illustrating a state before a passage is compressed according to an embodiment of the present disclosure. FIG. 8 is a view illustrating a state in which the passage is compressed according to an embodiment of the present disclosure.

As illustrated in FIG. 6, a method for manufacturing a unit cell for a fuel cell includes a preparation step S210, an arrangement step S220, and a compression step S230.

As illustrated in FIGS. 6 and 7, in the preparation step S210, the separator 20 may be prepared having the reaction area 23 located to correspond to the anode or the cathode of the unit cell, the first protrusion 41 protruding from the separator 20, and the second protrusion 42 protruding from the separator 20 and spaced apart from the first protrusion 41 with the reaction area 23 interposed therebetween.

In the arrangement step S220, the passage configured to guide the reaction gas that is to flow in the reaction area 23 may be provided. The porous passage 30 that protrudes to become farther away from the separator 20 and be higher than the first and second protrusions 41 and 42 may be arranged in parallel between the first and second protrusions 41 and 42.

As illustrated in FIGS. 6 and 8, in the compression step S230, the passage 30 may be compressed toward the separator 20, which may be in the thickness direction of the passage. The passage 30 is deformed to be lengthened in a transverse direction due to the compression. The passage 30 may be fixed to the separator 20 by medium or means of the first and second protrusions 41 and 42 by the force applied between the passage 30 and the first and second protrusions 41 and 42.

Further, as the passage 30 is deformed due to the compression, the passage 30 may be fixed to the separator 20 by medium or means of the first and second protrusions 41 and 42 by the force applied between and the first and second protrusions 41 and 42 of the fixed protrusion 40.

The passage 30 may be fixed by the reaction force by which the first and second protrusions 41 and 42 compress the passage 30, which is a reaction to the force by which the passage 30 compresses the first and second protrusions 41 and 42 from the inside toward the outside of the reaction area 23 due to the deformation of the passage 30.

Further, the passage 30 may have an initial length that is smaller than the separation distance between the first and second protrusions 41 and 42. Due to the compression of the compression step S230, the passage 30 may be deformed to be lengthened in a transverse direction until the passage 30 contacts at least the first and second protrusions 41 and 42. As an example, the passage 30 may be formed of a compressible material.

As an example, to stably fix the passage 30 between the first and second protrusions 41 and 42, the length of the passage before the compression may be determined in consideration of the separation distance between the first and second protrusions 41 and 42 and a degree to which the passage 30 is compressed.

As an example, the range of the initial length of the passage 30 may be 10 to 30 cm, and the compressed or extended length may be increased 1 to 3% of the initial length of the passage 30.

As an example, the length of the passage 30 may be 97 to 99% of the separation distance between the first and second protrusions 41 and 42 before the compression.

As an example, the degree to which the passage 30 is compressed may be by 50% or more of an original thickness of the passage 30.

As an example, when the area density of applied metal foam is 600 g/m2, the transverse length of the passage 30 is 237.10 mm before the compression, and is increased by 0.28 mm to 237.38 mm after the compression. The vertical length of the passage is 106.02 mm before the compression, and is increased by 0.19 mm to 106.2 mm after the compression.

As an example, when the area density of the passage 30 is 400 g/m2, the transverse length of the passage 30 is 237.09 mm before the compression, and is increased by 0.22 mm to 237.31 mm after the compression. The vertical length of the passage is 106.01 mm before the compression, and is increased by 0.11 mm to 106.11 mm after the compression.

The first and second protrusion 41 and 42 may be formed integrally with the separator 20.

As illustrated in FIGS. 6 and 7, the method for manufacturing a unit cell for a fuel cell according to the present embodiment may further include a seating step S221. In the seating step S221, the separator 20 and the first and second protrusions 41 and 42, which are prepared in the preparation step S210, may be seated on a seating jig 60.

As illustrated in FIG. 7, the seating jig 60 may include a bottom part 61 and a support part 62. The bottom part 61 may be seated against a surface among the surfaces of the separator on which the first and second protrusions 41 and 42 are not provided. The support part 62 may protrude from the bottom part 61 in a direction in which the first and second protrusions 41 and 42 protrude. The support part 62 protruding from the bottom part 61 may surround the separator 20.

A height by which the support part 62 protrudes from the bottom part 61 may be not less than a sum of the thickness of the separator 20 and the thickness of the protrusion 40 with respect to the direction in which the first and second protrusions 41 and 42 protrude.

The height by which the support part 62 protrudes from the bottom part 61 may be lower than the sum of the thickness of the separator 20 and the thickness of the passage 30.

In the compression step S230, as illustrated in FIG. 8, a press 63 is provided and has a shape of a flat plate. Until movement of the press 63 is stopped by the support part 62, the passage 30 may be compressed toward the separator 20 through the press 63.

As illustrated in FIG. 6, the method for manufacturing a unit cell for a fuel cell according to the present embodiment may further include a coupling step S211. In the coupling step S211, the first and second protrusions 41 and 42, if formed separately from the separator 20 prepared in the preparation step S210, may be coupled to the separator 20.

Because of the disclosed unit cells and the method for manufacturing a unit cell, the separator 20 and the passage 30 are integrally formed or joined such that the passage 30 is located in the MEA 10. Thus, fuel cell stacks may be precisely stacked on each other during assembly, so that productivity of the fuel cell stacks may be improved.

Accordingly, as a separator and a porous body are formed integrally or joined with each other such that the porous body is located on a surface of the MEA or the GDL, stacks may be precisely stacked on each other, so that productivity of the stacks may be improved.

The above description is merely an illustrative description of the technical spirit of the present disclosure. Various modifications and deformations may be made by those having ordinary skill in the art to which the present disclosure pertains without departing from the essential feature or features of the present disclosure. Thus, the embodiments that are disclosed and described in the present disclosure are not intended to be limiting but are instead for describing the technical spirit of the present disclosure. The scope of the technical spirit of the present disclosure is not limited by the embodiments. The protection scope of the present disclosure should be interpreted by the appended claims and all the technical spirit corresponding to the equivalents thereof should be interpreted to be included in the scope of a right of the present disclosure.

What is claimed is:

1. A method for manufacturing a unit cell for a fuel cell, the method comprising:
preparing a separator having a reaction area located to correspond to an anode or a cathode of the unit cell, a first protrusion protruding from the separator, and a second protrusion spaced apart from the first protrusion with the reaction area interposed therebetween;
providing a passage configured to guide a reaction gas that is to flow in the reaction area, and arranging a porous passage having a height protruding to become farther away from the separator and to be higher than the first and second protrusions between the first and second protrusions in parallel; and
compressing the porous passage toward the separator,
wherein the porous passage is fixed to the separator by medium of the first and second protrusions by a force applied between the porous passage and the protrusion as the passage is deformed or is apt to be deformed to be lengthened in a transverse direction due to the compression of the porous passage.

2. The method of claim 1, wherein the porous passage is fixed by a force by which the first and second protrusions compress the porous passage, the force being a reaction to a force by which the porous passage compresses the first and second protrusions from an inside toward an outside of the installation space due to the deformation of the porous passage.

3. The method of claim 1, wherein the porous passage has an initial length that is smaller than a separation distance between the first and second protrusions, and is deformed to be lengthened in a transverse direction until the passage contacts at least the first and second protrusions by the compression of the compressing of the porous passage.

4. The method of claim 1, further comprising
seating the separator and the first and second protrusions on a seating jig,
wherein the seating jig includes:
a bottom part seated against a surface among opposite surfaces of the separator on which the first and second protrusions are not provided; and
a support protruding from the bottom part in a direction in which the first and second protrusions protrude, the support surrounding the separator.

5. The method of claim 4, wherein a height by which the support protrudes from the bottom part is not less than a sum of a thickness of the separator and a thickness of the protrusion with respect to a direction in which the first and second protrusions protrude and is smaller than a sum of the thickness of the separator and a thickness of the porous passage.

6. The method of claim 4, wherein in the compressing of the porous passage with a press having a flat plate shape, until movement of the press is stopped by the support, the porous passage is compressed toward the separator through the press.

7. The method of claim 1, wherein the first and second protrusions are formed integrally with the separator.

8. The method of claim 1, further comprising:
coupling, to the separator, the first and second protrusions formed separately from the separator.
